(19) United States
(12) Patent Application Publication
(10) Pub. No.: US 2016/0055562 A1
(43) Pub. Date: Feb. 25, 2016

(54) PRODUCT DISPLAY MANAGEMENT SYSTEM

(71) Applicant: WINVERTS, INC., Tustin, CA (US)

(72) Inventor: SEUNG JIN KIM, IRVINE, CA (US)

(21) Appl. No.: 14/469,452

(22) Filed: Aug. 26, 2014

Related U.S. Application Data
(63) Continuation of application No. 14/468,154, filed on Aug. 25, 2014.

(51) Int. Cl. G06Q 30/06; G09G 5/00; G09G 5/12; H04W 4/00

(52) U.S. Cl. CPC G06Q 30/0623; H04W 4/008; G09G 5/003; G09G 5/12; G09G 2380/04; G09G 2370/022; G09G 2370/16

(57) ABSTRACT

Generally described, the present application relates to systems and methods for managing price and location information of products within a retail establishment. A product display management system can manage product information, such as a product price and product name, and product location information for products within the retail establishment. The product display management system includes a product display unit and a display unit tag. The product display management system can link products to the product display unit and provide the appropriate product information for display on the display unit. The product display management system can maintain the location information of each product display unit within the retail establishment. The product display management system can also manage access to network-based resources associated with a product.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

1. Field

This disclosure relates to an electronic shelf label and a product display management system for managing and displaying product information within a retail establishment.

2. Description of the Related Art

Generally described, product and price management can be a difficult and time consuming process for retail establishments, such as a store. Retail establishments must regularly update the price and product location information. When new products arrive, the products must be placed within a store with the appropriate price tags. Other products may need to be moved around to accommodate the new product. For example, the location of the new product and the products displaced by the new product will need to be updated. Each of the steps in this process may result in errors, such as recording an incorrect location of the new product or displaced product(s), not updating the location of the displaced products, incorrectly replacing price tags, and other logistical problems. As the size of the store increase, the process can be increasingly difficult to manage.

The location of each product is generally stored in a database that must be updated manually with the location of each product. As products are rearranged over time the location information associated with product may not be updated and the products can be “lost” within the store. This can be especially troublesome is large retail establishments. It can be a time consuming and labor intensive process to reassess the location and price information of all of the products in the retail establishment. When products are positioned in multiple locations, such as end caps on an aisle, it can be difficult to track each location.

When the location and pricing information is incorrect or difficult to find, customers may become confused and frustrated. Incorrect pricing information on products can result in numerous problems, such as dissatisfied customers, additional time dealing with customers, refunds, lost sales, and other issues. Many times customers will simply leave a retail establishment rather than dealing with frustrating pricing and/or location issues.

### SUMMARY

The present disclosure provides systems and methods for managing price and location information of products within a retail establishment that addresses problems and difficulties associated with existing product management systems. In a retail establishment, such as a grocery store, there are thousands of products that need to be tracked, priced, inventoried, sorted and organized. Generally, these are activities that need to be performed for multiple products every day, which can require significant time and energy to manage by employees. For example, the products may be rearranged, prices can change, promotional offers begin or end, new products are brought into the store, or any other action that can affect the position and/or price of the products within the store. This can result in a tremendous amount of work for the employee(s) and, can result in errors, such as incorrect pricing, incorrect product placement, misplaced products, incorrect product information, or other problems associated with the management of products with the store.

The product display management system described herein can manage product information, such as a product price and product name, and product location information for products within one or more stores without the disadvantages described above. The product display management system can provide a centralized management system that communicates with electronic shelf labels (ESL) that are associated with the various products within a store. Each product can be linked to an ESL and the association between the ESL and a product can be stored by the product display management system. An employee can associate a product with an ESL by scanning a product identifier and an ESL identifier, which can be used by the system to link the product and the ESL. The action can be performed by an employee terminal that can transmit the information to the product display management system wirelessly. The product management display system can communicate with each of the ESLs wirelessly and provide information for the products associated with the ESL. If product information is updated, the product management display system can update the display of the product information on the ESL. When a new product is received, or a product is moved, an employee can update the association between the product and the ESL.

The product display management system can advantageously help manage new products, prices changes, product updates and other logistical processes for a retail establishment. The product display management system can be used to automatically update prices when changes are made without the need to manually adjust any of the information. Seasonal pricing or other information could be provided to customers without the need to manually change out all of the information.

For example, if a new product is received, the new product can be positioned in the place of a previous product. The previous product can be moved to another location within the store. An employee can scan the new product identifier and the ESL identifier, the system can then associate the new product with the identified ESL. After the product and the ESL have been associated, the system can transfer the product information, such as name, price, and other product information, to the ESL, which can then be displayed by the ESL. The previous product identifier associated with the ESL is overwritten with the new product identifier and the product information associated with the identifier. The product display management system can then update the ESL to display the correct product information. The displaced product can be placed in another location, which can then be updated in the same manner as for the new product. Additionally, when product information needs to be updated, such as a price change, the system can be configured to update all of the ESLs associated with the product regardless of the number or location. This can be done for multiple stores using a single system.

One aspect of the invention provides an electronic shelf label system. The system comprises an electronic shelf label (ESL) device placed at a location within a retail establishment and comprising a display and a wireless communication module; a product display tag storing a display identifier, the product display tag configured to provide the display identifier to a mobile terminal via a communication channel established between the product display tag and the mobile terminal when the product display tag is in communication with the mobile terminal; at least one data store comprising data entries, wherein in the at least one data store the ESL is linked to the product display tag and further linked to a location identifier that identifies the location of the ESL within the retail establishment; and a control server configured to wirelessly communicate with the wireless communication module of the ESL device and further configured to wirelessly communicate with the mobile terminal. The control server is further configured to: receive the display identifier, receive a product identifier associated with a product, link or cause to link the product with the ESL device in the at least one data store in response to receipt of both the display identifier and the product identifier, and upon linking, transmit or cause to transmit information associated with the product to the ESL device for displaying on the display.

In the foregoing system, linking the product with the ESL device may cause linking the product to the location identifier in the at least one data store. The control server may be configured to link the product with the ESL device upon consecutive receipt of the display identifier and the product identifier within a predetermined period. The control server may be configured to link the product with the ESL device upon receipt of a command to link the display identifier and the product identifier. The wireless communication module may be a ZigBee communication module. The wireless communication channel may be a near field communication (NFC) channel. The product display tag may further store a uniform resource identifier (URI) for providing to a mobile device when the mobile device establishes a communication channel with the product display tag. Upon linking of the product with the ESL device, the control server may be configured to link the URI stored in the product display tag with another URI associated with a webpage of the product such that a network enabled device requesting the URI stored in the product display tag may be directed to the other URI associated with the page containing information relating to the product.

Still in the foregoing system, the product identifier and the display identifier may be from a single employee terminal. The product identifier may be an optical identification code placed on the product or a package of the product. The information about the product may comprise at least one selected from the group consisting of product price, product name, informational product data, and product page URI. The information associated with the product may be stored in the at least one data store. The product display tag and the ESL device are integrated as a single piece. The product display tag may be an NFC device or optical computer readable code. The ESL device may be further configured to transmit a status message to the control server, the status message indicating a status of the ESL device.

Another aspect of the invention provides a computer-implemented method for managing products of a retail establishment comprising: providing at least one data store accessible by a control server and storing data entries relating to electronic shelf labels placed at various locations within a retail establishment; receiving a display identifier, the display identifier identifying an electronic shelf label (ESL), wherein in the at least one data store, the display identifier is linked to a location identifier for identifying a location of the ESL within the retail establishment; receiving a product identifier, the product identifier identifying a product; linking or causing to link, by a control server, the display identifier to the product identifier by overwriting in the at least one data store a previously stored product identifier that was previously linked to the display identifier, wherein by linking the display identifier to the product identifier, the product is linked to the location of the ESL within the retail establishment; and transmitting or causing to transmit, by the control server, product information associated with the product identifier to the ESL device identified by the display identifier, wherein the product information overwrites previous product information stored in the ESL device and the ESL device is configured to display the product information on an electronic display.

In the foregoing method, the product identifier and the display identifier may be wirelessly received from an employee terminal or the ESL device. The display identifier may be stored in a display unit tag provided along with the ESL, wherein the display unit tag and ESL are integrated as a single piece or provided as separate pieces. The product display tag stores a URI that may be linked to the display identifier in the at least one database, wherein the method further comprises linking the URI stored in the product display tag with another URI associated with a webpage of the product, wherein a network enabled device requesting the URI stored in the product display tag may be directed to the URI associated with the page containing information relating to the product. The method may further comprise receiving an instruction to link the display identifier to the product identifier from a mobile terminal. Linking the display identifier to the product identifier may be caused by receipt of both the display identifier and the product identifier sent from a single device. Linking the display identifier to the product identifier may be caused by consecutive receipts of the display identifier and the product identifier within a predetermined period, in which no intervening receipt of another identifier from the single device between the two consecutive receipts.

Still another aspect of the invention provides a non-transitory physical computer storage comprising computer-executable instructions stored thereon that, when executed in one or more processors, are configured to execute operations comprising: receiving a display identifier, the display identifier identifying an electronic shelf label (ESL) device that is linked to a location identifier in at least one data store, the location identifier identifying a location of the ESL within a retail establishment receiving a product identifier, the product identifier identifying a product that is associated with product information in the at least one data store; subsequent to receipt of the display identifier and product identifier, linking or causing to link the display identifier to the product identifier in the at least one data store, wherein by linking the display identifier to the product identifier, the product is linked to the location of the ESL within the retail establishment; and subsequent to linking, transmitting or causing to transmit the product information associated with the product to the ESL device identified by the display identifier, wherein upon receipt of the product information the ESL device is configured to display at least part of the product information on an electronic display.

### BRIEF DESCRIPTION OF THE DRAWINGS

FIG. 1 illustrates a network environment for the product display management system.

FIG. 2 illustrates an embodiment of an exemplary product data store for use with the product display management system.

FIG. 3 illustrates an embodiment of an exemplary display unit data store for use with the product display management system.

FIGS. 4A and 4B illustrate embodiments of exemplary correspondence data stores for use with the product display management system.

FIG. 5 illustrates an example of an embodiment of a shelving system using ESL devices for use with the product display management system.

FIGS. 6A and 6B illustrate an embodiment of a product display including a display unit tag and a display unit.

FIG. 7 illustrates an embodiment of a flow diagram for a display unit update process.

### DETAILED DESCRIPTION

Generally described, the product display management system can use a plurality of product display units. The product display management system can link products to the product display unit and provide the product information for display on the display unit. The product display management system can maintain the location information of each product display unit within the retail establishment (e.g., Aisle 18, Shelf 1). The product display management system can also manage access to network-based resources associated with a product.

The product display unit, such as an electronic shelf label (ESL) devices, provides product information to consumers. The display unit can have an electronic display and a wireless transceiver that it can use to communicate with the product display management system. The electronic display can display one or more of the price, the product name, a URI for a product page and additional product information. The wireless transceiver can be a low power transceiver, such as a Zigbee compatible device.

The display unit tag can be a device storing computer readable information that includes an identifier associated with the product display unit. The display unit tag can also include additional information that can be accessed by a mobile computing device. The additional information can include a uniform resource identifier (“URI”). The URI can direct a consumer to a product page associated with a product linked to the display unit tag. The display unit tag can be a passive device that does not require a power supply, such as a near field communication (“NFC”) tag or a radio frequency identification (“RFID”) tag, an optical computer readable code such as a QR code or bar code, or a virtual tag stored within the display unit. The product display unit tag and the display unit can be distinct components that are not physically or electrically coupled together.

The following example represents an illustrative embodiment of the product display management system. An employee at a store, such as an electronics store, can use an employee terminal, such as a dedicated inventory management device to interact with the product display management system. The employee terminal can be used to retrieve a product identifier from a product identification label and a display unit identifier from the display unit tag. The identifiers can be received by the employee terminal by any means necessary. For example, the identifiers can be received by scanning an optical computer readable code or communicating with an NFC device. The employee terminal can receive the identifiers in any order. The employee terminal may have a user input that can be used to configure the employee terminal to receive product identifiers and display unit identifiers.

The employee terminal can transmit the product identifier and display unit identifier to a control server of the product display management system. The employee terminal can transmit the identifiers with instructions to link the product identifier with the display unit identifier. The control server can associate the product with the display unit based on the product identifier and the display unit identifier. The product display management system can have a correspondence data store that is configured to link products to product display units. After the product has been linked to the product display unit, the product display management system can identify and transmit product information to the identified product display unit. The display unit can then display the price and other information associated with the product.

In some embodiments, the display unit tag can have a store URI. The URI can be accessed by a network-capable device, such as a smart phone. The product display management system can be configured to direct users that access the store URI to a URI for a product page of the product associated with the product display. The product page could provide information and this product page could include promotional information, coupons, product reviews or other information related to the product. The product page could be associated with the product display management system or a third party.

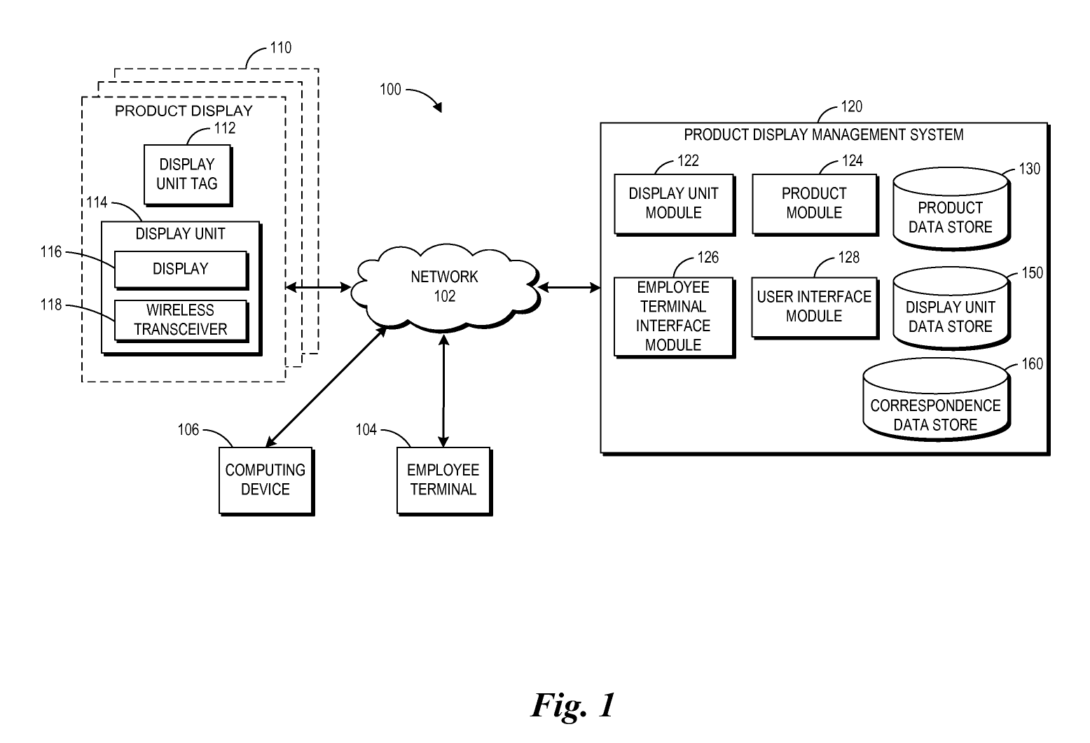

FIG. 1 illustrates a network-based operating environment 100 for a product display management system 100. The operating environment 100 includes a plurality of product displays 110, a network 102, an employee terminal 104 and a product display management system 120. The product display management system 120, employee terminal 104 and product display can be in communication via the network 102.

### Product Display

The product display 110 includes a display unit tag 112 and a display unit 114, also referred to as an electronic shelf label (ESL). The display unit 114 includes an electronic display 116 and a wireless transceiver 118.

The display unit 114 can include any type of electronic display 116 capable of displaying product information. For example, the display can be an LCD display, LED display, dot matrix display, electronic paper or electronic ink display, or other type of display capable of displaying product information. In some embodiments the display can be a monochrome or color display, the display can be segmented to display different types of information in different segments.

### Wireless Transceiver

The wireless transceiver 118 can be used for bi-directional communication over the network 102 with the product display management system 120. The wireless transceiver can be a low power transceiver such as a Zigbee compatible transceiver. The wireless transceiver 118 can receive information, such as product information, from the product display management system 120. The display unit can be a battery powered device or electrically coupled to a fixed or wired power source.

### Display Unit Tag

The display unit tag 112 can be a physical or digital object that is configured to store information associated with the display unit 114. The display unit tag 112 can store an identifier that identifies the display unit 114. The display unit identifier can be a code associated with the display unit, such as a serial number or other identifier that can be linked or associated with the display unit. Each display unit tag can store a unique code. The display unit tag 112 can be configured to include additional information such as uniform resource identifier (URI) information (e.g., www_tag200info_xyz). The display unit tag 112 is configured to store the information in a format that is readable by a computing device. The display unit tag 112 can be configured to provide the stored information by communicating with the mobile terminal of a worker or customer.

The display unit tag 112 can be positioned on or near the display unit 114. The display unit tag 112 could be physically coupled or affixed to the display unit 114 or integrated within the display unit 114. In some embodiments, the display unit tag 112 can be a physical tag that includes a near field communication (NFC) device. The NFC device can communicate using radio frequency communication in accordance with the NFC specifications. The NFC device can be a passive device that does not require a power source. In some embodiments, the display unit tag 112 can be an optical code, such as a barcode or a QR code.

A data store can be used to store, track and manage each of the display unit identifiers, such as a display unit data store 130 in the product display management system 120.

### Employee Terminal

The employee terminal 104 can be a computing device configured to retrieve information from products and display unit tags 112, and communicate the information to the product display management system 120. The employee terminal 104 can be a dedicated device configured for this purpose. In some embodiments, the employee terminal can be a general purpose computing device, such as a smart phone or tablet computing device with software that is configured to retrieve the information from products and display unit tags and communicate the information to the product display management system 120. The employee terminal 104 has the appropriate hardware and software for interacting and communicating with the products and display unit tags 112. For example, the employee terminal 104 can have a scanner or other mechanism that can be used to receive a product identifier from a product or the packaging of a product, and/or receive a display unit identifier from the display unit tag 112. The employee terminal 104 can be configured to communicate with the product and/or display unit tag using wireless communication technologies such as near field communication or radio frequency communication in order to receive the product identifiers and display unit tag identifiers, and provide the identifiers wirelessly over the network 102 to the product display management system 120. The employee terminal 104 can have user inputs configured for a user to interact with the products and display unit tags, and to communicate the information received from the products and display unit tags to the product display management system.

### Linking Product and Display Unit

The employee terminal 104 can be used to associate or link the display units 114 with a product by receiving the product identifier and the display unit identifier and transmitting the information to the product display management system 120. The employee terminal 104 can transmit the identifiers with an instruction to the product display management system 120 to associate or link the product identifier and the display unit identifier. In response, the display management system 120 can cause to update the appropriate data store. The employee terminal 104 can include a user input that can be used to initiate the transmission of the identifiers to the product display management system 120. In some embodiments the employee terminal 104 can automatically transmit the identifiers to the product display management system 120 when a product identifier and a display tag identifier are received within a defined time frame. For example, if an employee terminal receives a product identifier and a display tag identifier within a predetermined period, such as 15 seconds, the identifiers can be automatically sent to the product display management system 120 with an instruction to associate the identified product with the identified display unit. In some embodiments, the employee terminal 104 can automatically send identifiers that it receives and the product display management system 120 can determine whether the identifiers were received within a defined time frame of the product display managed system 120.

### Network

The communication network 102 may be any wired network, wireless network or combination thereof. In addition, the communication network 102 may be a personal area network, local area network, wide area network, cable network, satellite network, cellular telephone network or combination thereof. Protocols and components for communicating via the Internet or any of the other aforementioned types of communication networks are well known to those skilled in the art of computer communications and thus, need not be described in more detail herein. The network 102 could be a network compatible with IEEE 802.15 standards and specifications, such as a Zigbee compatible network.

### Product Display Management System

The product display management system 120 comprises a display unit module 122, a product module 124, an employee terminal interface module 126, a user interface module 128, a product data store 130, a display unit data store 150 and a correspondence data store 160. The product display management system 120 can be used to manage the product and the product display information within a retail establishment and/or for a plurality of retail establishments. The product display management system 120 may be implemented in hardware and/or software and may, for instance, include one or more servers having physical computer hardware configured to implement computer executable instructions for performing various features that will be described herein. The one or more servers may be geographically disbursed or geographically co-located, for instance, in one or more data centers.

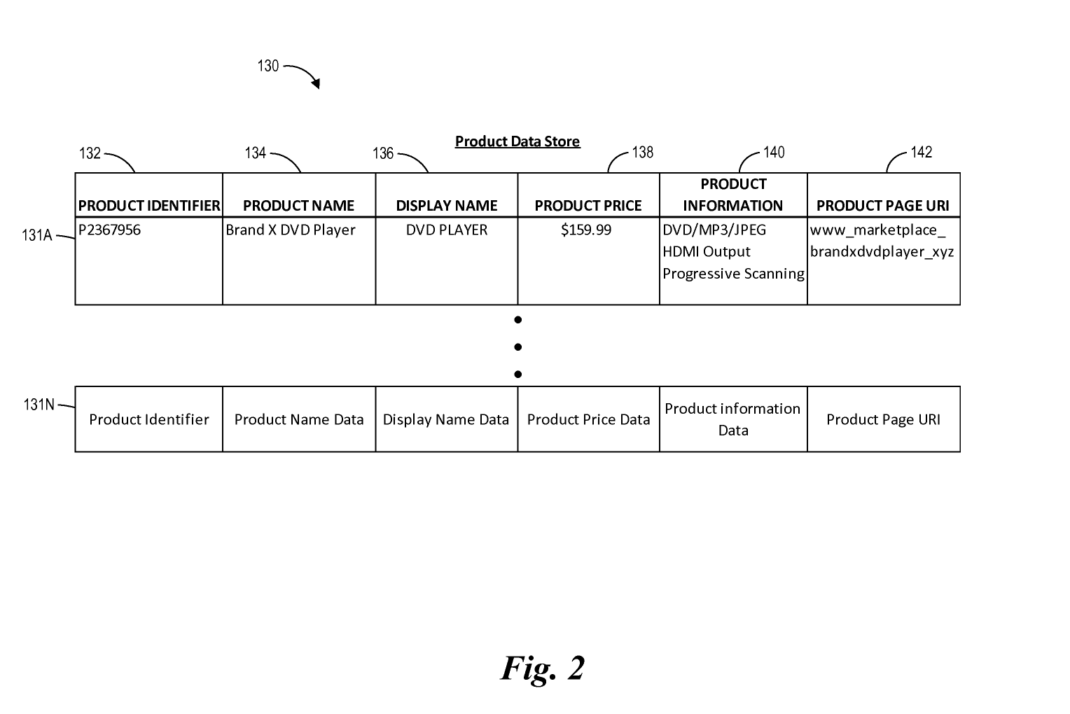

The product display management system 120 can include one or more servers, which can communicate with display units 114 and employee terminals 104 over the network 102 and which can provide access to various services of the interactive computing system 110. The services and features of the product display management system 120 can be implemented by the display unit module 122, the product module 124, the employee terminal interface module 126 and/or the user interface module 128. These services and features can be implemented in physical computer hardware on the servers or in separate computing devices. Moreover, the processing of the various components or services of the product display management system 120 can be distributed across multiple machines, networks, or other computing resources. The various components or services of the product display management system 120 can also be implemented in one or more virtual machines or hosted computing environment (e.g., “cloud”) resources, rather than in dedicated servers. Likewise, the data repositories shown, namely the product data store 130, the display unit data store 150 and correspondence data store 160, can represent local and/or remote, physical and/or logical data storage, including, for example, storage area networks or other distributed storage systems. In some embodiments, the information stored in the product data store 130, the display unit data store 150 and correspondence data store 160 can be configured as a single data store, or multiple data stores. The structure illustrated in the exemplary data stores illustrated in FIGS. 2-4 represents exemplary data stores that can be used to implement the functionality and processed described herein and does not limit the usage of other data store configurations. Executable code modules that implement various functionalities of the product display management system 120 can be stored in the product data store 130, the display unit data store 132, on memories of the servers and/or on other types of non-transitory computer-readable storage media. The product display management system 120 can be configured so that each of the components shown can communicate with any other components.

### Display Unit Module

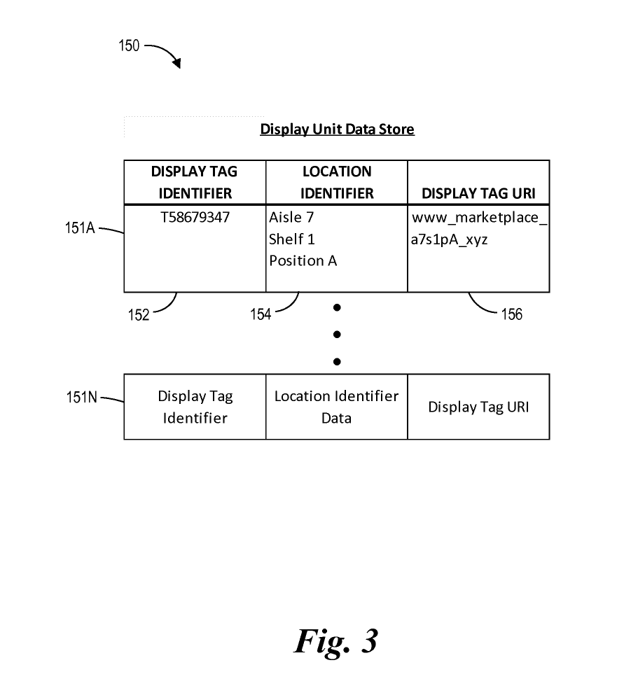

The display unit module 122 can be used to manage the display units 114 and communicate with display units 114 via the network 102. The display unit module 122 can engage in bi-directional communication with the display unit 114 via the wireless transceiver 118. The display unit module 122 can provide product data to the display unit 114 for display on the display 116. The display unit module 122 can manage the display unit data store 150. An exemplary embodiment of a display unit data store is illustrated in FIG. 3.

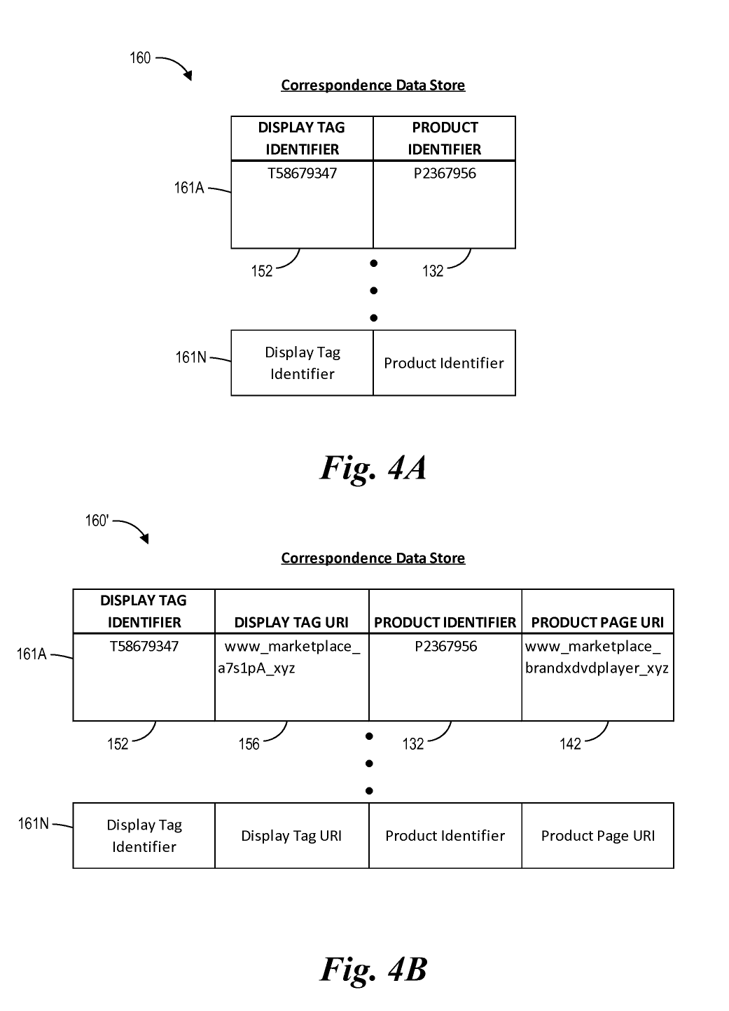

The display unit module 122 can associate a product with a display unit 114 based on a product identifier and a display unit identifier. The display unit module 122 can update a correspondence data store 160 to associate or link the display unit and 114 a specific product placed next to the display unit 114. The correspondence data store is explained in more detail below in association with FIGS. 4A and 4B. The display unit module 122 can communicate with other modules and data stores to retrieve product data for the product associated with a specific display unit 114: The display unit module 122 can update a display unit 114 when the product data associated with product displayed on the display unit 114 is updated. For example, the display unit module 122 can be configured to update one or more display units when product data for a product is updated in the product data store individually 130.

The display unit module 122 can also manage information stored on the display unit tag 112. When the display unit 112 contains a URI, the display unit module 122 can associate or link the URI stored on the display unit tag 112 with a product information page of the product associated with the display unit 114. By associating the URI stored on the display unit tag 112 with the product information page, a customer can be directed to the product information page of the product when accessing the URI information stored on the display unit tag 112.

### Product Module

The product module 124 is responsible for maintaining product information associated with products stored in the product data store 130. The product module 124 can be in communication with the product data store 130. The product data store 130 can contain data relating to the products that are in one or more retail establishments. An exemplary embodiment of the product data store 130 is displayed in FIG. 2. The product module 124 can update the product data store 130.

### Employee Terminal Interface Module

The employee terminal interface module 126 can interface and communicate with the employee terminal 104. The employee terminal interface module 126 can provide a specific interface, such as a specific application programming interface (API) that is used by the employee terminal 104 to communicate with the product display management system 120. The employee terminal interface module 126 can be configured to communicate with the employee terminal 104 to send and receive information associated with the products and display units 114. The employee terminal interface module 126 can determine when the employee terminal 104 is providing information for associating or linking a product with a display unit. The employee terminal 104 interface module 126 can receive a command or indication from an employee terminal 104 that a product identifier and a display unit identifier should be associated. In some embodiments, the employee terminal interface module 126 can determine based on the timing of the receipt of the product identifier and a display unit identifier whether to update the association between a product and a display unit without receiving a command or indication from the employee terminal 104.

### User Interface Module

The user interface module 128 can be used to provide a user interface to user, such as an employee, on a computing device 106 accessing the product display management system 120. The user interface module 128 can provide an interface for the user to access the information stored within the product display management system 120, such as the product data store 130, the display unit data store 150, or the correspondence data store 160. The user interface module 128 can provide a user with functionality to edit product information, such as editing the price of a product.

### Product Data Store

FIG. 2 illustrates an embodiment of a product data store 130. The illustrated embodiment provides examples of data that can be stored within the product data store 130. The examples shown herein do not limit the information that can be stored within a data store or the format of information. Depending on the requirements of the system additional, fewer, and/or different data elements can be maintained within the product data store 130.

The product data store 130 includes a plurality of data records 131A-N. Each data record contains product data for a specific product. In this embodiment, the product data includes product identifier 132, product name 134, display name 136, product price 138, product information 140 and a product page URI 142. The product identifier 132 can be used to identify the product. The product identifier 132 can be a unique identifier, such as a UPC code, that identifies the product. The product identifier 132 can be used to query the database and access information stored within the data record associated with the product. The product name 134 can be a name associated with the product. The display name 136 can be a name that is for display on the display unit 114, which may be a shortened version of the product name 134, alias or other name that can be displayed on the display unit within a store. For example, there may be limitations on the number of characters or information that can be displayed on the display unit. The product price 138 can indicate the price of the product. In some embodiments, the product price 138 may include more than one price based different currencies or options associated with the product. For example, the product price 138 can be configured to display different prices for each variation of a specific product.

The product information 140 can include additional information associated with the product, such as technical specifications, warranty information, or other information associated with the product. The product information 140 can be configured for display on a display unit 114, a user interface within a store or other display that can be used to access product information. The product page URI 142 includes a URI for the product information page. The URI can be for a product information page that provides additional information about the product. The product page URI 142 can be a product information page that is maintained and updated by the product display management system 120. In some embodiments, the product page URI 142 can be for a webpage that is external to the product display management system 120 and is maintained by a third party, such as the product manufacturer. In some embodiments, the product information page can include coupons or other promotional information associated with the product. For example, the product information page could identify other products that are generally purchased with the product, such as accessories. The product information page can identify the location of the cross-promotional products within the store. In some embodiments, the product information page can be accessed by a user with a network-capable device that receives a URI from the display unit tag and is directed to the product page URI. In some embodiments, the product page URI and the display unit tag URI are the same although not limited thereto.

### Display Unit Data Store

FIG. 3 illustrates an exemplary embodiment of the display unit data store 150. The illustrated embodiment provides examples of data that can be stored within the display unit data store 150. The examples shown herein do not limit the information or its format that can be stored within a data store. Depending on the requirements of the system additional, fewer, and/or different data elements can be maintained within the display unit data store 150. The display unit data store 150 includes a plurality of data records 151A-N. Each data record contains data for a specific display unit 114. In this embodiment, the display unit data store 150 includes a display unit identifier 152, a location identifier 154 and a display tag URI 156.

The display unit identifier 152 can be an identifier stored in the display unit tag 112. The display unit identifier 152 is used by the product display management system 120 to identify a specific display unit 114 within one or more retail establishments. The display unit identifier 152 can be used to query the database and access information stored within the data record associated with the specific display unit 114. The display unit identifier 152 can be based on a unique identifier associated with the display unit 114, such as the serial number of the display unit 114. The display unit identifier 152 can be programmed into the display unit tag 112 so that it can be accessed by an employee terminal 104. In some embodiments, the display unit identifier 152 can be based on a static identifier that is stored in the display unit tag 112. In some embodiments the display unit 114 and the display unit tag 112 can have different identifiers. In such embodiments, the display tag identifier can be paired with the display unit identifier to associate the display unit tag 112 and the display unit 114. For example, the display unit tag 112 could have an identifier, such as a unique encoded value or number, and the display unit 114 could have a unique identifier, such as a serial number, both of which could be stored and linked together.

The location identifier (also referred to as “address”) 154 is data that identifies the location of the display unit 114 within the retail establishment. In embodiments relating to multiple retail establishments, the location identifier 154 may also include a store identifier. In the illustrated data record, the location identifier indicates that the display unit 114 would be located at display tag is aisle 7, shelf 1, at position A. The type of location data stored within the data store depends on the location data that is used by the retail establishment. For example, the retail establishment could use a coordinate system, aisle system, or other type of system for identifying locations within the retail establishment. Regardless of the system used by the retail establishment, the location identifier 154 identifies the location of the display unit 114 within the retail establishment. The location identifier 154 can be updated if the display unit 114 is moved to a different location within the retail establishment. For example, an employee can move the display unit to a new location within the store and update the data store with the new location.

The display tag URI 156 can be a URI that is stored within the display unit tag 112. The display unit tag 112 can store a static URI that can be communicated to a user that interacts with the display unit tag 112. For example, a user with a network-enabled mobile device could receive the URI from the display unit tag 112 and request to access its associated webpage. The product display management system 120 can configure the display tag URI to direct the user's device to a webpage associated with the product or any other webpage. For example, the user could be directed to the product page URI 142. In some embodiments, the display unit tag 112 and the display unit data store 180 do not store a display tag URI 142.

### Correspondence Data Store

FIGS. 4A and 4B illustrate embodiments of correspondence data stores 160 and 160′ for associating display units 114 with products. The illustrated embodiments provide examples of data that can be stored within the correspondence data store 160, 160′. The examples shown herein do not limit the information or its format that can be stored within a data store. Depending on the requirements of the system additional, fewer, and/or different data elements can be maintained within the correspondence data store 160, 160′. The correspondence data store 160, 160′ includes a plurality of data records 161A-N. Each data record contains data for a specific display unit 114. In the embodiment illustrated in FIG. 4A, the correspondence data store 160 includes a display unit tag identifier 152 and a product identifier 132.

The product identifier 132 is the same product identifier as is stored in the product data store 130. The display unit identifier 152 is the same display unit identifier as is stored in the display unit data store 150. The correspondence data store 160 is used to associate each display unit 114 with a specific product by pairing, also referred to as linking, a product identifier with a display unit identifier. The correspondence data store 160 can have an entry for each display unit 114 maintained within the retail establishment(s). The product display management system 120 can link a product to a specific display unit 114 by populating the data record 161 with the product identifier of a specific product. In some embodiments, a product may be associated with a plurality of different display unit identifiers 152. For example, a product can be positioned at multiple locations within a retail establishment; at each location the same product will be associated with a different display unit. In this manner, all of the display units 114 associated with a product can be tracked and updated simultaneously without searching through the store. When a different product is positioned at a display location associated with or assigned to a display unit 114, the old product identifier can be overwritten by the new product identifier.

FIG. 4B illustrates alternative embodiment of the type of information that can be stored in the correspondence data store 160′. In this embodiment, the correspondence data store 160′ is configured to store the display tag identifier 152, the product identifier 132, and additional information associated with the product and the display unit 114. Specifically, the correspondence data store 160′ includes references to the display tag URI 156 and the product page URI 142. This embodiment of the data store can be used to direct network requests for the display tag URI 156 to the product page URI 142 associated with the product. In this manner, each display tag URI 156 can be configured to direct a user device to the product page URI 142 stored in the data store. The correspondence data store 160′ may include additional information, such as product data that is displayed on display unit 114. The correspondence data store 160 may be combined with one of the other data stores such as the display unit data store 150 and/or the product data store 130.

### Electronic Shelf Labels

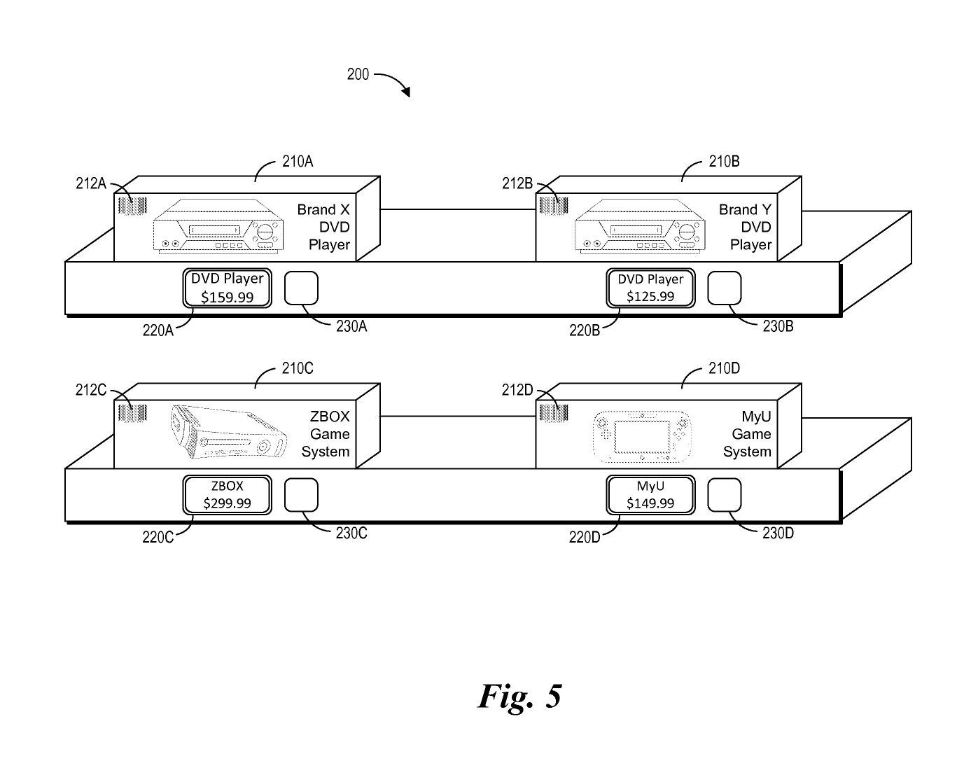

FIG. 5 illustrates an embodiment of shelving units 200 within a retail establishment that is utilizing the product display management system 120. The exemplary shelving system illustrates four products 210A-B. Each product 210A-D has a product identification label 212A-D that stores a product identifier. In the illustrated embodiment, the product identification label 212A-D is optical computer generated code. In some embodiments the product identification label can be a QR code, an NFC or RFID tag, which can be located inside or outside of the product packaging. Display units 220A-D and display unit tags 230A-D are associated with each of the products 210A-D, respectively. Each display unit 220A-D displays product data associated with the product 210A-D. For example, in this embodiment, display unit 220A, associated with product 210A (i.e., a Brand X DVD player), displays a price of $159.99; display unit 220B, associated with product 210B (i.e., Brand Y DVD player), displays a price of $125.99; display unit 220C, associated with product 210C (i.e., a Z box game system), displays a price of $299.99; and display unit 220D, associated with product 210D (i.e., a My U game system) displays a price of $149.99. Each element of the display is explained in more detail below.

### Display Unit

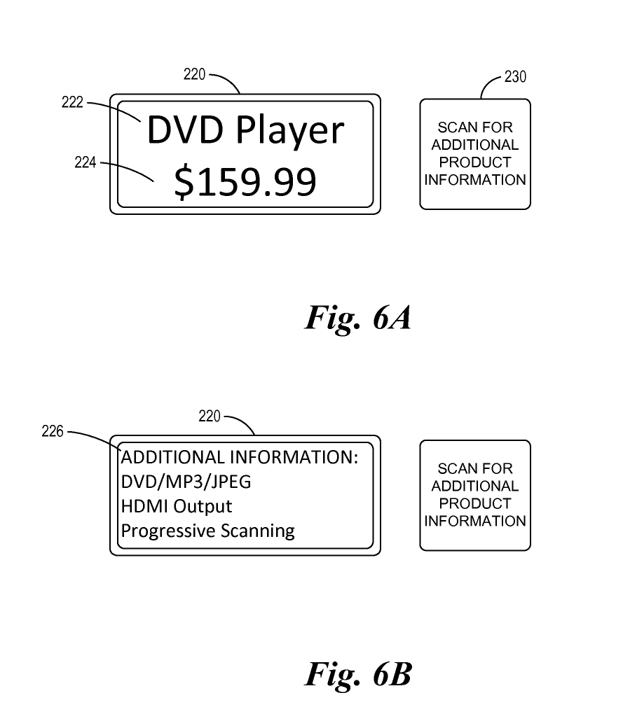

FIGS. 6A and 6B provide a more detailed view of the display units 220 illustrated in FIG. 5. The display unit 220 displays product data contained in the product data store 130. In this example, the display name 222 (i.e., DVD Player) of the product and the product price 224 (i.e., $159.99) are displayed. As illustrated, the display name can be different from the product name (i.e., Brand X DVD Player). In FIG. 6B, the same display shows a different screen of the display unit 220, which is displaying additional product information 226 stored in the product data store 130. In some embodiments, there can be manual controls on the display unit 220 that allow a customer to scroll through various pages of the product data. In some embodiments, there can be a time delay where the display unit 220 cycles through the different pages at a defined time period. For example, the time period could be every two seconds or any other predetermined time period. This can be used for a smaller display to provide additional information about a product.

The display unit 220 receives the product data from the product display management system 120 via a wireless transceiver. The display unit 220 can bi-directionally communicate information with the product display management system 120. In some embodiments, the display unit 220 can provide display unit status updates to the product display management system 120. For example, the display unit 220 could communicate error codes, low battery alerts or other information that can provide the product display management system 120 with information that allows the display units 220 to be replaced or repaired with minimum difficulty.

### Display Unit Tag

In this embodiment, the display unit tag 230 is a separate component that is not coupled to or integrated into the display unit 220. In some embodiments, the display unit tag 230 is integrated into the display unit or positioned where it is not visible to the customer, such as adhered to the back side of the display unit 220. The display unit tag 230 can provide customer instructions for interacting with the tag (e.g., scan for additional product information). In some embodiments, informational text and/or figures may be on the display unit 220. The display unit tag 230 can communicate wirelessly with a mobile computing device. In some embodiments, the display unit tag 230 does not require a power source although not limited thereto. For example, in some embodiments, the display unit tag is a passive NFC device.

By using NFC communication a user can interact and communicate with the display unit tag 230 by positioning a mobile computing device within close proximity to the display unit tag 230. The information stored within the display unit tag can be communicated to the mobile computing device. For example, the display unit tag 230 could provide a URI that directs the user mobile device to a product page for the product 210. For ease of use, it can be beneficial to use NFC communication devices or tags that can communicate with devices within a specified distance. In some embodiments, the display unit tag provides a visible or optical computer readable code such as QR code or bar code that can be scanned by a customer device to access the information stored within the display unit tag 230.

### Product Display Update Routine

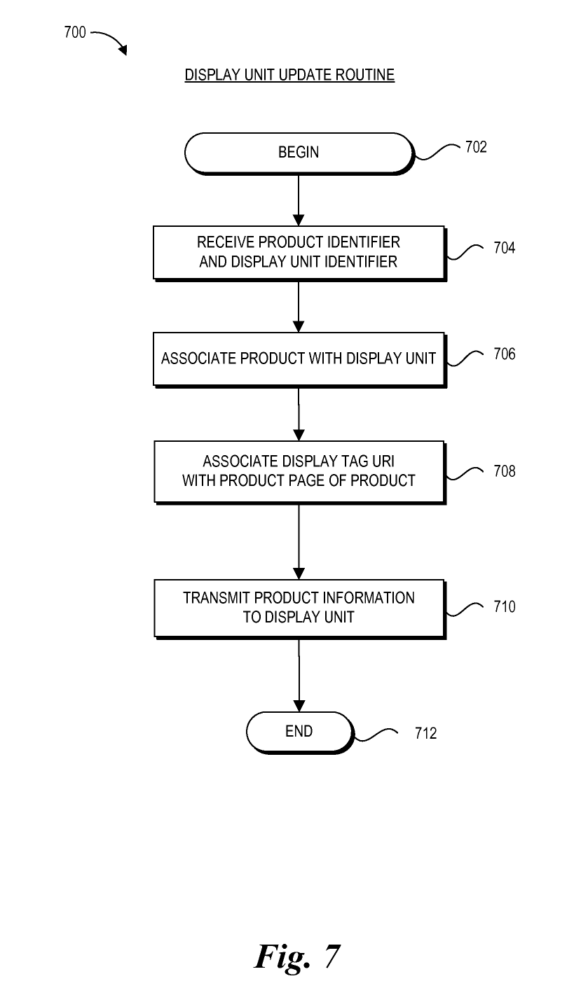

FIG. 7 illustrates a flowchart of an embodiment of a display unit update routine 700. The routine 700 can be implemented by the product display management system 120. The display unit update process is a process that would be used to update the display unit 114 either when a new product is being placed or being rearranged within the store.

The routine 700 begins at block 702. At block 704, the product display management system 120 receives a product identifier and a display unit identifier. The product identifier and the display unit identifier can be sent from an employee terminal 104. In some embodiments, the product display management system 120 can receive the product identifier and display unit identifier from another source, such as the display unit 114. The employee terminal 104 can determine the product identifier for the product by scanning, reading, communicating or otherwise receiving the product identifier from a product identification label on or within the product or the packaging of the product. For example, the product identifier can be stored in an optical computer readable code or an NFC tag. The display unit tag 112 can be an NFC tag or an optical computer readable code. The employee terminal 104 can determine the product identifier for the product by scanning, reading, communicating or otherwise receiving the display unit identifier from the display unit tag 112. For example, the product identifier can be stored in an optical computer readable code or an NFC tag. The employee terminal 104 can send the product identifier and display unit identifier with an instruction to associate the product identifier and the display unit identifier. The identifiers may be sent simultaneously or sequentially with or without the instruction. After receiving the product identifier and display unit identifier, the product display management system 120 can process the information.

At block 706, the product display management system 120 processes product identifier and the display unit identifier. The product display management system can associate the product with the display unit 114 based on the display tag identifier and the product identifier or link. In some embodiments, the product display management system 120 can associate the display tag identifier and the product identifier based on a received instruction. For example, the instruction can instruct the product display management system 120 to link the product identifier to the display unit identifier. In some embodiments, the product identifier can be associated with the display unit in a correspondence data store 160.

As one example, when a product is initially shelved within a retail establishment, the product data store can receive a data store entry in the data store relating to the new product. The product can then be positioned in a desired location. The desired location may include one or more product displays 110. For example, the product may be intended for multiple locations within the store and thereby may be associated with a plurality of product displays 110. At each location, an employee can scan the product identifier and the display unit tag 112 with the employee terminal in order to link the product with the display unit 114. The product display management system 120 can link the product with the display unit 114 associated with the display tag identifier stored in the display unit tag 112. The process can be repeated for each display unit 114 and/or for each product.

As another example, an existing product can be replaced by another product. The product identifier of the product replacing the existing product can be scanned along with the display unit tag 112. The product display management system 120 can overwrite the previous product identifier associated with the display unit identifier with the new product identifier. The association of the previous product with the display unit 114 can be completely overwritten by the replacing product.

In another example, the display unit 114 can be replaced. When a display unit 114 is replaced, the display unit tag, which also includes the display tag identifier, can be linked to the new display unit. The display unit 114 may include a serial number or other identifier that can be used by the product display management system to link the display unit 114 to the display tag identifier.

At block 708, the product display management system 120 can update the URI information associated with the product and the display unit 114. In some embodiments, block 708 can be an optional step. Based on the display tag identifier and the product identifier, the product display management system 120 can configure a URI stored in the display unit tag 112 to direct user devices to a product information page associated with the product. The product information page of the product can have a different URI from one stored in the display unit tag 112. In some embodiments, the product display management system 120 configures the product information page so that it has the same URI as the display unit tag 112. In some embodiments, the product display management system 120 configures the display unit tag 112 to store the same URI as the URI for the product information page. In some embodiments, the association between the URI data of the product and the display unit tag 112 can be updated in a correspondence data store 160. For example, the product display management system 120 can automatically associate the URI information based on the product identifier and the display unit identifier.

At block 710, the product display management system 120 can transmit product data associated with the product to the display unit 114 for display. The product data can be information stored the product data store 130. The wireless transceiver 118 on the display unit 114 can communicate with the product display management system 120. The transceiver can receive and transmit information from/to the product display management system 120. The transceiver 118 can be a low power transceiver that is battery powered. After the information is transferred the process ends at block 712.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more general purpose computers or processors. The code modules may be stored in any type of non-transitory computer-readable medium or other computer storage device. Some or all the methods may alternatively be embodied in specialized computer hardware. In addition, the components referred to herein may be implemented in hardware, software, firmware or a combination thereof.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and algorithm elements described in connection with the embodiments disclosed herein can be implemented as electronic hardware, computer software or combinations of both. To clearly illustrate this interchangeability of hardware and software, various illustrative components, blocks, modules and elements have been described above generally in teens of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or the entire signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC. The ASIC can reside in a user terminal. In the alternative, the processor and the storage medium can reside as discrete components in a user terminal.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each is present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure and protected by the following claims.

1. An electronic shelf label system comprising:
an electronic shelf label (ESL) device comprising an electronic display, an ESL identifier and a wireless communication module that are integrated together in a single piece placed within a retail establishment, wherein the ESL identifier identifies the ESL device and is provided on or in the single piece ESL device for being captured or received by a mobile device;
at least one data store comprising data entries;
one or more ESL data entries stored in the at least one data store and associated with the ESL device, wherein the one or more ESL data entries comprise the ESL identifier;
one or more product data entries stored in the at least one data store and associated with a product for sale within the retail establishment, wherein the one or more product data entries comprise a price of the product and a product identifier, wherein the product identifier identifies the product and is provided on or in the product for being captured or received by a mobile device; and
at least one control server configured to wirelessly communicate with the wireless communication module of the ESL device and further configured to wirelessly communicate with the mobile terminal, the at least one control server configured to:
receive, from a mobile terminal, the ESL identifier captured or received from the single piece ESL device,
receive, from the same mobile terminal, the product identifier captured or received from the product,
link or cause to link the product with the ESL device in the at least one data store in response to receipt of both the ESL identifier and the product identifier,
subsequent to receipt of the product identifier, communicate with the at least one data store to retrieve the price of the product from the one or more product data entries associated with the product, and
subsequent to linking, transmit or cause to transmit the price of the product to the wireless communication module of the ESL device for displaying on the electronic display such that the ESL device is automatically updated with the price of the product and displays the price on the electronic display in response to linking of the product and the ESL device.

2. The system of claim 1, wherein the ESL device is placed at a specific location within the retail establishment, wherein the specific location is identified with a location identifier in the at least one data store, wherein the ESL device is linked to the specific location with the ESL identifier and the location identifier in the at least one data store, wherein linking the product with the ESL device causes linking the product to the specific location with the product identifier and the location identifier in the at least one data store.

3. The system of claim 1, wherein the control server is configured to link the product with the ESL device upon consecutive receipt of the display identifier and the product identifier within a predetermined period without intervening receipt of another ESL identifier for identifying another ESL device or intervening receipt of another product identifier for identifying another product.

4. The system of claim 1, wherein the control server is configured to link the product with the ESL device upon receipt of a command to link the display identifier and the product identifier.

5. The system of claim 1, wherein the wireless communication module is a ZigBee communication module.

6. The system of claim 1, wherein the ESL device comprises an NFC tag that stores the ESL identifier, wherein the NFC tag is configured to provide the ESL identifier to the mobile terminal via a near field communication (NFC) channel when the mobile terminal tags the NFC tag.

7. The system of claim 6, wherein the NFC tag further stores a tag uniform resource identifier (URI) for providing to a mobile device when the mobile device establishes the NFC channel with the NFC tag.

8. The system of claim 7, wherein upon linking of the product with the ESL device, the control server is further configured to link the tag URI with a product URI of a webpage associated with the product such that a network enabled device receiving the tag URI from the NFC tag of the ESL device is directed to the product URI to open the webpage associated with the product.

9. The system of claim 1, wherein the mobile terminal capturing or receiving the product identifier and the ESL identifier is an employee terminal of the retail establishment.

10. The system of claim 1, wherein the product identifier is or corresponds to an optical identification code placed on the product including a package of the product.

11. The system of claim 1, wherein subsequent to receipt of the product identifier, the at least one control server configured to communicate with the at least one data store to retrieve a name of the product along with the price of the product from the one or more product data entries,
wherein subsequent to linking, the control server is further configured to transmit or cause to transmit the name of the product to the wireless communication module of the ESL device for displaying on the electronic display along with the price of the product such that the ESL device is automatically updated with the name of the product and displays the name on the electronic display along with the price of the product in response to linking of the product and the ESL device.

12. The system of claim 1, wherein the ESL device comprises a first URI for opening a first webpage on a networked mobile device, wherein the product is associated with a second webpage having a second URI that is stored in the one or more data entries, wherein upon linking the ESL device with the product, the control server is configured to connect the second URI and the first URI for opening the second webpage when the networked mobile device attempts to open the first webpage with the first URI.

13. The system of claim 12, wherein the ESL device provides the first URI for being captured or received by the networked mobile device for opening the first webpage.

14. The system of claim 1, wherein the ESL device comprises an optical computer readable code that stores the ESL identifier.

15. The system of claim 1, wherein the ESL device is further configured to transmit a status message to the control server, the status message indicating a status of the ESL device.

16. The system of claim 1, further comprising a non-transitory physical computer storage comprising computer-executable instructions stored thereon that, when executed in one or more processors, are configured to execute operations comprising:
receiving the ESL identifier identifying the electronic shelf label (ESL) device that is linked to a location identifier in at least one data store, the location identifier identifying a location of the ESL device within the retail establishment;
receiving the product identifier identifying the product;
subsequent to receipt of the ESL identifier and the product identifier, linking or causing to link the ESL device with the product in the at least one data store, by which the product is linked to the location of the ESL device within the retail establishment;
subsequent to linking, retrieving the price and name of the product from the at least one data store; and
subsequently, transmitting or causing to transmit the price and name of the product to the wireless communication module of the ESL device identified by the ESL identifier such that the ESL device is automatically updated with the price and name of the product and displays the price on the electronic display in response to linking.

17. The system of claim 16, wherein the ESL device comprises a first URI for opening a first webpage on a networked mobile device, wherein the product is associated with a second webpage having a second URI that is stored in the one or more data entries, wherein upon linking the ESL device with the product, the control server is configured to connect the second URI and the first URI for opening the second webpage when the networked mobile device attempts to open the first webpage with the first URI.

18. The system of claim 11, wherein the ESL device comprises a first URI for opening a first webpage on a networked mobile device, wherein the product is associated with a second webpage having a second URI that is stored in the one or more data entries, wherein upon linking the ESL device with the product, the control server is configured to connect the second URI and the first URI for opening the second webpage when the networked mobile device attempts to open the first webpage with the first URI.

19. The system of claim 11, wherein the ESL device is placed at a specific location within the retail establishment, wherein the specific location is identified with a location identifier in the at least one data store, wherein the ESL device is linked to the specific location with the ESL identifier and the location identifier in the at least one data store, wherein linking the product with the ESL device causes linking the product to the specific location with the product identifier and the location identifier in the at least one data store.

20. The system of claim 19, wherein the ESL device comprises a first URI for opening a first webpage on a networked mobile device, wherein the product is associated with a second webpage having a second URI that is stored in the one or more data entries, wherein upon linking the ESL device with the product, the control server is configured to connect the second URI and the first URI for opening the second webpage when the networked mobile device attempts to open the first webpage with the first URI.
